(19) United States
(12) Patent Application Publication
(10) Pub. No.: US 2004/0101241 A1
(43) Pub. Date: May 27, 2004

(54) Fiber grating/DC fiber hybrid dispersion compensation module

(76) Inventors: Glenn E. Kohnke, Corning, NY (US); Vitor M. Schneider, Painted Post, NY (US)

Correspondence Address: CORNING INCORPORATED, SP-TI-3-1, CORNING, NY, 14831

(21) Appl. No.: 10/302,129

(22) Filed: Nov. 22, 2002

(51) Int. Cl. G02B 6/34; G02B 6/26

(52) U.S. Cl. 385/37; 385/27; 385/123

(57) ABSTRACT

An apparatus for compensating for chromatic dispersion over a wavelength band includes a dispersion compensating optical fiber that is coupled to an optical grating, which compensates for residual dispersion in the optical signal.

### FIELD OF THE INVENTION

The present invention relates generally to chromatic dispersion and dispersion slope compensation, and in particular to a method and apparatus using both optical gratings and dispersion compensating optical fibers to achieve the compensation.

### BACKGROUND

Optical transmission systems, including optical fiber communication systems, have become an attractive alternative for carrying voice and data at high speeds. In optical transmission systems, waveform degradation due to chromatic dispersion in the optical transmission medium can be problematic, particularly as transmission speeds continue to increase.

Chromatic dispersion results from the fact that in transmission media such as glass optical waveguides, the higher the frequency of the optical signal, the greater the refractive index. As such, higher frequency components of optical signals will “slow down,” and contrastingly, lower frequency signals will “speed-up”.

In digital optical communications, where the optical signal is ideally a square wave, bit-spreading due to chromatic dispersion can be particularly problematic. To this end, as the “fast frequencies” slow down and the “slow frequencies” in the signal speed up as a result of chromatic dispersion, the shape of the waveform can be substantially impacted. The effects of this type of dispersion are a spreading of the original pulse in time, causing it to overflow in the time slot that has already been allotted to another bit. When the overflow becomes excessive, intersymbol interference (ISI) may result. ISI may result in an increase in the bit-error rate to unacceptable levels. Moreover, the change in the chromatic dispersion as a function of wavelength, dispersion slope, can also adversely impact the signal quality.

As can be appreciated, control of the total chromatic dispersion and dispersion slope in an optical communication system is important, particularly in long-haul, and high-speed applications. In particular, it is necessary to reduce the total dispersion and dispersion slope to a point where its contribution to the bit-error rate of the signal is acceptable.

Dispersion compensation modules (DCMs) have been developed using dispersion compensating (DC) optical fiber. These devices have been used for correcting chromatic dispersion in optical communication links.

FIG. 1 shows the overall chromatic dispersion 101 of 100 km of commonly used optical fiber with the required dispersion compensation 102 and the dispersion compensation 103 available using a known DC fiber. As can be appreciated, due to the large dispersion slope of the commonly used fiber, the known DC fiber cannot provide the required dispersion compensation with a corresponding linear and large negative dispersion slope over the wavelength band. This results in a residual chromatic dispersion over the wavelength band of interest.

FIG. 2 shows an example of residual dispersion 201 for an optical link operating in the C-band. This residual dispersion is the dispersion that cannot be compensated by the known DC fiber used for dispersion compensation, and is parabolic in shape. This residual dispersion must be suitably compensated to avoid the deleterious effects of dispersion discussed above. For example, over a long-haul system, in which a number of such DCM's are concatanated, this residual dispersion may be on the order of 100 ps/nm and greater. This is unacceptably high.

Banded dispersion compensation, in which a dedicated DCM is used to compensate the dispersion of a sub-band (e.g., a subset of wavelength channels) of a wavelength band, is known. However, this requires a DCM for each sub-band, and thereby, adds complexity and cost to the system.

What is needed, therefore, is a method and apparatus that overcomes at least the shortcomings of the known methods and apparati.

### SUMMARY

In accordance with an exemplary embodiment of the present invention, an apparatus for compensating for chromatic dispersion over a wavelength band includes a dispersion compensating optical fiber that is coupled to an optical grating, which substantially compensates for residual dispersion over the band.

In accordance with another exemplary embodiment of the present invention, a method of compensating for chromatic dispersion over a wavelength band includes providing a dispersion compensating optical fiber, which provides dispersion compensation in an optical signal over the band, and an optical grating that substantially compensates for residual dispersion over the band.

### BRIEF DESCRIPTION OF THE DRAWINGS

The invention is based understood from the following detailed description when read with the accompanying drawing figures. It is emphasized that the various features in the drawing figures may not necessarily be drawn to scale. In fact, the dimensions of the various features may be arbitrarily increased or decreased for clarity of discussion.

FIG. 1 is a graphical representation of the dispersion of a 100 km length of a known optical fiber and the needed dispersion compensation with the DC fiber dispersion superposed thereover.

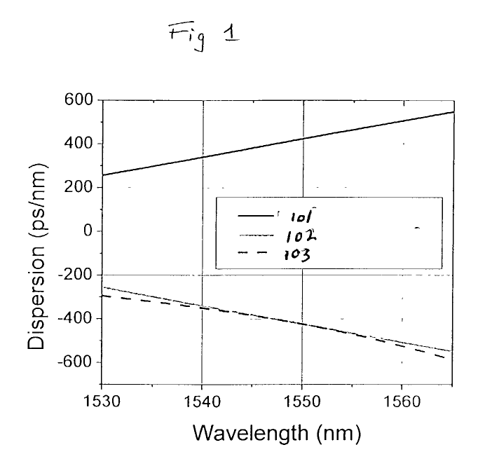

FIG. 2 is a graphical representation of the residual dispersion of a DCM with a known DC fiber.

FIG. 3 is a schematic representation of a dispersion compensation apparatus in accordance with an exemplary embodiment of the present invention.

FIG. 4 is a schematic representation of a dispersion compensation apparatus in accordance with another exemplary embodiment of the present invention.

FIG. 5 is a graphical representation of the target dispersion to compensate for the residual dispersion shown in FIG. 2.

FIG. 6 is a graphical representation of the period of a grating as a function of grating length in accordance with an exemplary embodiment of the present invention.

FIG. 7 is a graphical representation of the dispersion versus wavelength of a target grating with that of a grating in accordance with an exemplary embodiment superposed thereover.

FIG. 8 is a graphical representation of the error between the target grating dispersion and actual grating dispersion in according to an exemplary embodiment of the present invention.

FIG. 9 is a graphical representation of the reflection and transmission spectra of a grating in accordance with an exemplary embodiment of the present invention.

FIG. 10 is a graphical representation of the target dispersion and the grating dispersion of an exemplary embodiment of the present invention, for a dispersion target with a negative offset.

FIG. 11 is a graphical representation of the period of a grating (with a negative dispersion offset) as a function of grating length in accordance with an exemplary embodiment of the present invention.

FIG. 12 is a graphical representation of the reflection and transmission spectra of a grating with a negative dispersion offset in accordance with an exemplary embodiment of the present invention.

FIG. 13 is a graphical representation of the corrective dispersion for DC fibers with differing κ-values needed to target the residual dispersion of a 100 km link.

FIG. 14 is a graphical representation of the corrective dispersion shifted for DC fibers with differing κ-values needed to target the residual dispersion of a 100 km link.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

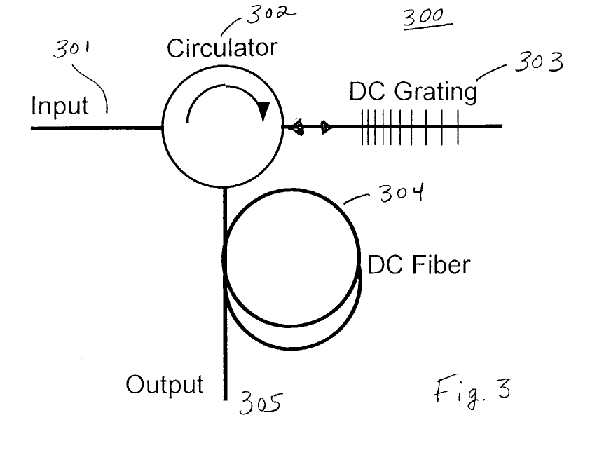

FIG. 3 shows a dispersion compensation apparatus 300 (DCA) in accordance with an exemplary embodiment of the present invention. The DCA 300 receives an input optical signal at an input 301. The input optical signal may be a wavelength division multiplexed (WDM) or dense WDM (DWDM) optical signal having a plurality of wavelength channels. The input optical signal has a bandwidth on the order of approximately 40 nm. For example, the input optical signal may be a DWDM signal over the C-band from approximately 1530 nm to approximately 1570 nm. Of course, this is merely illustrative; it being noted that the input optical signal may comply with other standard wavelength channel bands. In fact the bandwidth of the input signal may be as great as approximately 100 nm.

Illustratively, the input optical signal is incident on a three-port optical circulator 302, a device well known to one of ordinary skill in the photonics arts. The signal exits a port of the circulator 302, and traverses a dispersion compensating grating 303. The grating 303 is a reflective grating that is useful in mitigating residual dispersion in the broadband optical signal. Illustratively, the grating is a chirped fiber Bragg grating, although it does not have to be fiber-based. In one exemplary embodiment, the grating is a positive offset dispersion grating, while in another exemplary embodiment, the grating may be a negative offset dispersion grating. Further details of the grating 303 and its function are described herein.

It is noted that while gratings have been used in mitigating the deleterious affects of chromatic dispersion, these uses are limited to single channel or a limited wavelength subband of the communication band. To wit, known uses of gratings alone for effective dispersion compensation do not include broadband (e.g., over the entire C-band) dispersion compensation as addressed by the DCA 300 and the grating 303 of the exemplary embodiment of FIG. 3. Rather, effective known applications of gratings for dispersion compensation are limited to single channel and banded (e.g., a subset of the wavelength channels of the communication band) dispersion compensation solutions.

Upon reflection from the grating 303, the optical signal is input to the circulator 302 as shown and emerges from another port thereof. The optical signal then traverses a length of dispersion compensating optical fiber 304, and then is output at an output 305. This DC fiber 304 is useful in compensating for the majority of the chromatic dispersion of the band, but an amount of residual remains. This residual dispersion is usefully compensated for by the grating 303, which is tailored to provide the suitable compensatory chromatic dispersion.

The DCA 300 may be disposed at an end of a relatively long link of an optical communication. This link is illustratively 100 km in length; although the link may have a length in the range of approximately 10 km to approximately 200 km. Furthermore, this may be one section of a longer optical link, or may be the entire optical link. Finally, the DCA 300 of this and other exemplary embodiments of the present invention is generally the only such device required over the length of the link. To this end, known dispersion compensation techniques require a number of such dispersion compensating devices, each of which provides compensation at a particular sub-band of the wavelength band; whereas the DCA 300 alone can accomplish the desired compensation of non-linear chromatic dispersion over the entire wavelength band. These and other features and advantages of the present invention will become more apparent as the present description continues.

As discussed, the present invention as described through exemplary embodiments herein accomplishes broadband dispersion compensation using a DC fiber (or similar waveguide, or device) and a DC grating. To this end, the DC fiber providing dispersion compensation over the wavelength band; and the grating correcting/compensating for residual dispersion over the entire wavelength range of the optical communication band. The grating is chosen/tailored to provide the inverse (with an offset) of the residual dispersion at each point along the wavelength spectrum. Some considerations to meet this desired end of exemplary embodiments of the present invention are discussed presently.

As is known, the dispersion is the change in the group delay per unit change in wavelength. The maximum attainable group delay scales with length. In the applications described here, the values of dispersion are relatively small and allow broadband devices with reasonable grating lengths. As will be shown, the flexibility of grating technology enables unusual dispersion characteristics. Chirped fiber Bragg gratings are known for use in dispersion compensation. The grating period is varied as a function of length (thus the term ‘chirped’) to change the Bragg wavelength along the length of the grating. The Bragg wavelength, λ_{B}, is related to the grating period, Λ, by:

λ_{B}=2n_{eff}Λ (1)

where n_{eff} is the effective index of the waveguide mode. By varying the period linearly along the grating length, the relative group delay as a function of wavelength in reflection is also linear since, for example, short wavelengths are reflected at one end while long wavelengths are reflected at the other end of the grating.

The delay, τ, in the optical signal from a fiber grating as a function of wavelength, λ, is given by:

$$τ ( λ ) = 2 ( \frac{{n}_{eff}}{c} ) z ( λ ) \qquad ( 2 )$$

where z(λ) is the position from the start of the grating at which a wavelength, λ, is reflected. The factor of two accounts for the round trip traveling into and out of the grating. The dispersion, D(λ), is then

$$D ( λ ) = \frac{ⅆ τ}{ⅆ λ} ( λ ) = 2 ( \frac{n}{c} ) \frac{ⅆ z}{ⅆ λ} ( λ ) \qquad ( 3 )$$

The target dispersion, D(λ), is available in the format of a numerical table. For a particular desired dispersion, it is necessary to determine z(λ) for the grating. Inverting and integrating equation (3) yields:

$$z ( λ ) = \frac{1}{2 ( \frac{n}{c} ) {λ}_{0}} {\int }_{{λ}_{o}}^{λ} D ( x ) ⅆ x \qquad ( 4 )$$

where λₒ is the shortest wavelength in the data set. Λ vs. z is needed to fabricate the grating; and this is determined by replacing λ with λ_{B} from eqn. (1) to yield z(λ).

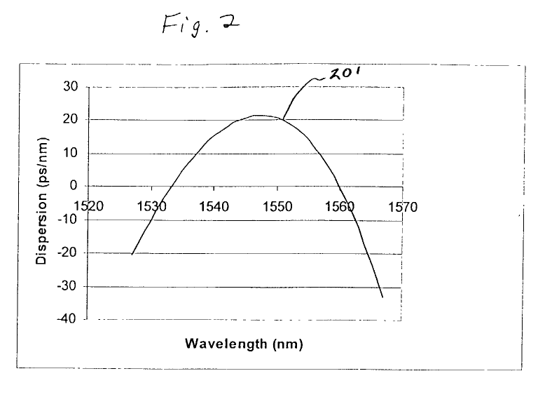

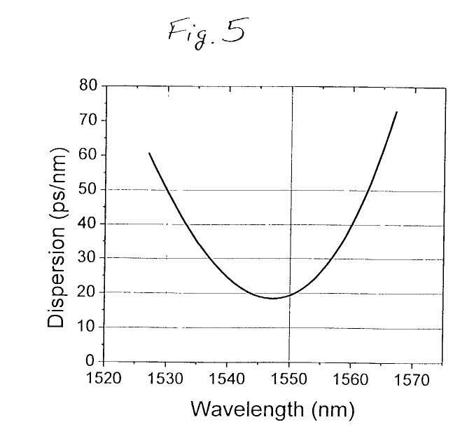

The desired dispersion of the DC grating 303 is shown in FIG. 5. This desired compensatory dispersion (or target dispersion) is simply the mirror image or inverse (with an offset) of the residual dispersion of an optical link containing only the DC Fiber 304 as shown in FIG. 2. The offset, such as that shown, may be chosen to provide a minimum dispersion value. Without this minimum level of dispersion, the grating reflectivity decreases with decreasing amount of dispersion for a constant refractive index modulation. For example, dispersion of approximately ±15 ps/nm can produce a grating reflectivity of 99% for a refractive index modulation of 1×10⁻³. It is noted that larger changes in the indices of refraction of the grating may be useful in certain applications.

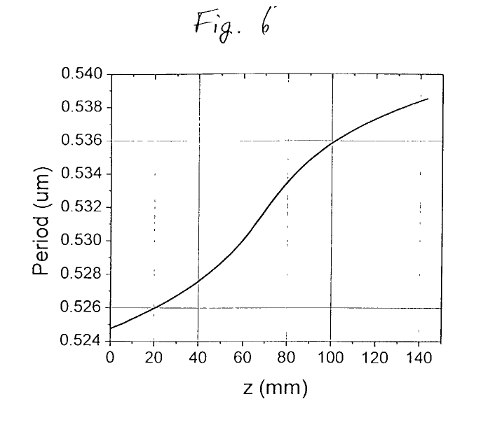

FIG. 6 shows the grating period versus grating length (z) of an illustrative grating in accordance with an exemplary embodiment of the present invention. An illustrative wavelength range over which dispersion compensation is effected in accordance with an exemplary embodiment is illustratively 1527 nm to 1567 nm. The grating period as a function of length is as shown in FIG. 6 and the total length is 143.2 mm. The grating has a modulated index of refraction change of 0.001 and a constant average index of 1.45298 using a 1% index delta fiber. The grating strength is uniform along the grating length. In this design example, an effective index of refraction of 1.45 was used to generate the grating period function. The grating data (illustratively modeled) were shifted by 2 nm to account for this discrepancy between the design effective index and the effective index of the waveguide mode used in the grating model.

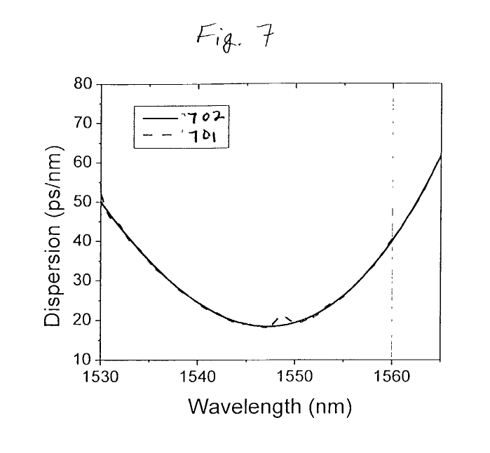

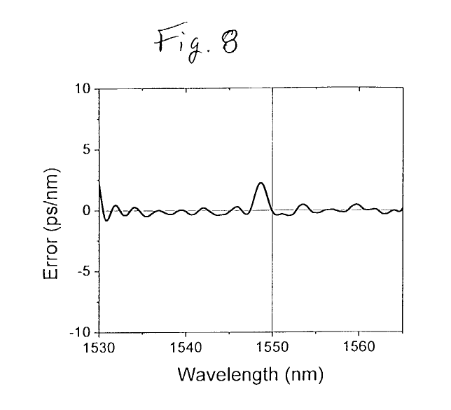

With these illustrative grating parameters, the resulting corrective dispersion 701 is shown compared to the target dispersion 702 in FIG. 7 for wavelengths between 1530 nm and 1565 nm. To wit, the illustrative grating provides corrective dispersion that compensates for the residual dispersion over this wavelength band. The error between the target dispersion and the modeled grating dispersion is plotted in FIG. 8. The ripples in the error are due to the relatively limited number of data points in the residual dispersion data set and the number of points used to model the grating.

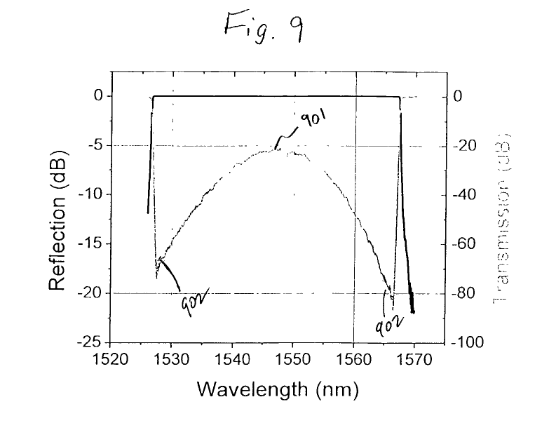

As mentioned above, the reflection characteristics are a function of dispersion and the magnitude of the modulated index change. The minimum reflection determines the insertion loss of the device. Spectrally dependent loss is also a concern in a broadband device such as the illustrative grating. FIG. 9 includes graphs of both the transmission and reflection of the grating. The minimum reflection in the operating bandwidth of the device is approximately −0.05 dB. The strong wavelength dependence of the transmission spectrum follows the dispersion variation. At the center of the band (e.g., near point 901), the dispersion is low and the grating becomes more transmissive. At the edges of the band (e.g., near points 902) where the dispersion is high, the light effectively sees a longer length of the grating (optical path length) and the transmission is reduced. This wavelength dependence is immaterial as long as the transmission remains below approximately −20 dB. For higher levels of transmission, a wavelength dependent loss is introduced on the order of tenths of a dB (maximum transmission of −10 dB corresponds to 0.5 dB of wavelength dependent loss). Maintaining a low transmission depends directly on the magnitude of the induced index change, which is 0.001 in this case. The transmission may also be lowered by raising the minimum dispersion value at the center of the band but at the expense of increasing the grating length.

In accordance with another exemplary embodiment of the present invention a negative dispersion offset grating is used. That is, the grating has a negative dispersion offset rather than a positive dispersion offset but has the same shape as in the positive dispersion case. One advantage of using a negative offset grating in an exemplary embodiment is the reduction the amount of DC fiber used in the module. To this end, the total amount of DC fiber that is needed is on the order of about 3.5 km for compensation in a link of 100 km of LEAF fiber, a known type of optical fiber. Using the negative dispersion offset grating of the exemplary embodiment, the required DC fiber (e.g., DC fiber 304) is reduced by an amount on the order of 0.7 km. Beneficially, the reduction in the required DC fiber length results in a decrease in the insertion loss of the DCA as well a reduction in the manufacturing cost of the DCA.

It is noted that the dispersion compensation realized using this type of grating is substantially identical to the exemplary embodiment described above in which a positive offset grating is used.

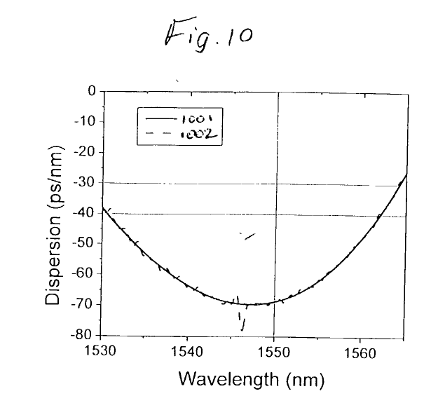

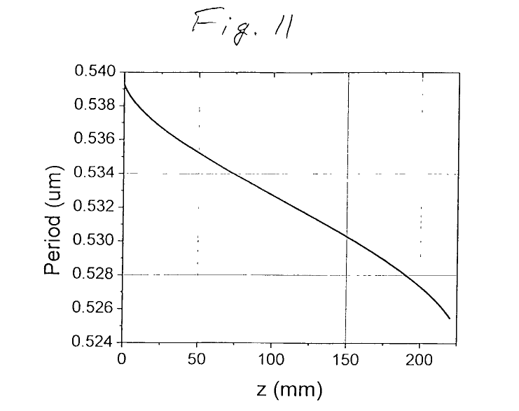

For example, FIG. 10 shows the target corrective dispersion 1001 along with the corrective dispersion using a negative offset grating using modulated index of refraction of 0.001 and a grating length of 220.4 mm. The grating period as a function of length for this illustrative embodiment is shown in FIG. 11.

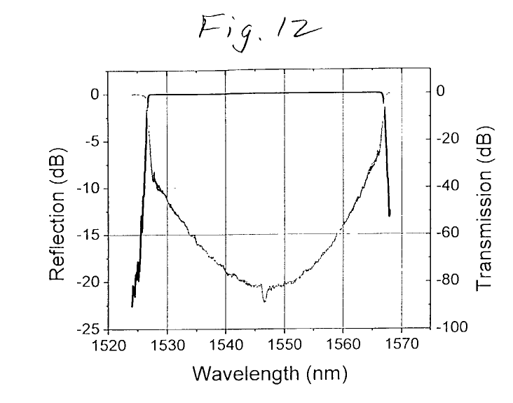

The transmission and reflection of this grating design is plotted in FIG. 12. The very strong spectral dependence of the transmission spectrum is evident again with higher transmission in regions of low dispersion. As with the previous exemplary embodiment, the reflection is maintained above −0.05 dB for the appropriate choice of modulated index and dispersion offset. It is noted that the negative dispersion offset grating may require a longer grating, which may be less desirable than the shorter grating design using a positive dispersion offset. The user may have to weight this against the benefit of requiring less DC fiber when using a negative dispersion offset grating in the DCA.

The target dispersions in the exemplary embodiments thus far described assume a “perfect” dispersion compensating fiber with a κ=50 where κ is the ratio of the dispersion to the dispersion slope at 1550 nm. In practice, it is difficult to manufacture a fiber with the precise κrequired for optimized dispersion compensation.

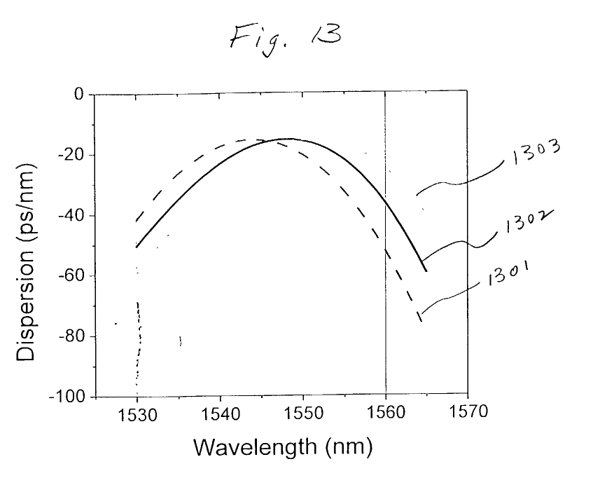

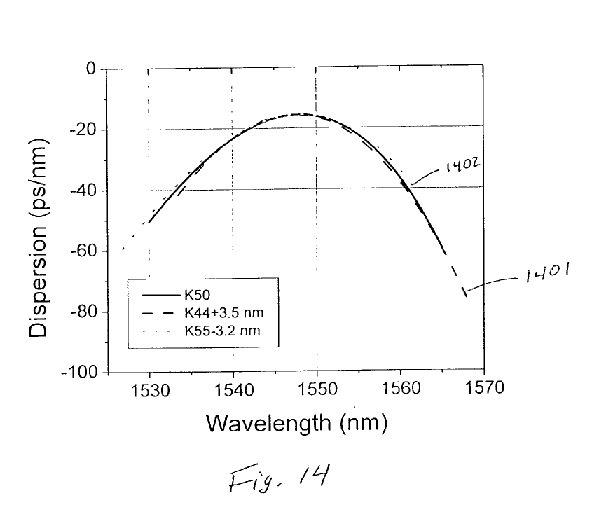

The residual dispersion is plotted in FIG. 13 for three κ-values (κ=44, curve 1301; κ=50, curve 1302; and κ=55, curve 1303) for a 100 km optical link. The dispersion curves shown in FIG. 13 have very similar shapes but are significantly shifted in wavelength. The κ=44 and κ=55 curves are shown shifted in wavelength and plotted on top of the κ=50 curve in FIG. 14. The shifts required are +3.5 nm for κ=44 (curve 1402) and −3.2 nm for κ=55 (curve 1402). To accommodate these shifts, fibers with different κ values each require a slightly different grating design; or one grating design is used and adjusted to match the particular fiber. The second option is attractive since it only requires one grating design. The drawback to this approach is that the bandwidth of the grating is increased by approximately 7 nm to accommodate the amount of wavelength shift required for tuning. This increases the length of the grating.

It is noted that in addition to the use of the grating, trim fiber may be used to compensate for the shifts in the dispersion curves depending on the value of κ for the particular DC fiber. Trim fiber is a known type of fiber, and while it may be advantageous in addition to the grating in some cases to compensate for residual dispersion, its benefits must be weighed against the additional insertion loss of the trim fiber. An example of such a trim fiber is disclosed in U.S. Patent Publication Number 2002/0102084 A1 to Srikant. The disclosure of this publication is incorporated herein by reference.

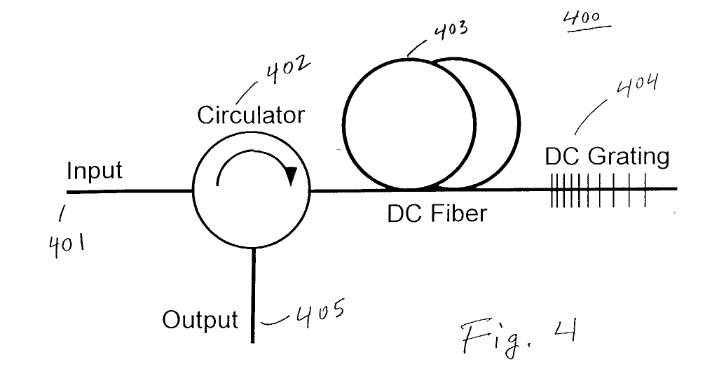

Finally, in the exemplary embodiment shown in FIG. 3, the DCA 300 has the grating 303 placed in the optical path of the light before the DC fiber 304. Since the grating/circulator combination will have some loss, it is useful to place this loss prior to the DC fiber to reduce the power that may contribute to nonlinear effects in the DC fiber. Alternatively, the grating may be used as a reflector after propagating through half of the required DC fiber as shown in FIG. 4. To wit, the DCA 400 includes an input 401 that receives the input optical signal; a circulator 402; a DC fiber 403; a grating 404; and an output 405. This implementation uses half the quantity of DC fiber 403 and allows the grating 404 to be used both as a reflector and a dispersion correction element. In this case, the grating may be written directly into the DC fiber if desired and if the fiber exhibits sufficient photosensitivity. The results attained through this exemplary embodiment are substantially the same as those attained via the exemplary embodiments described above.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An apparatus for compensating for chromatic dispersion over a broad wavelength band, comprising:
a dispersion compensating (DC) optical fiber, which substantially compensates for the chromatic dispersion in an optical signal; and
an optical grating, which substantially compensates for residual dispersion in said optical signal.

2. An apparatus as recited in claim 1, wherein the apparatus compensates for dispersion over an entire wavelength band.

3. An apparatus as recited in claim 2, wherein said wavelength band has a bandwidth of approximately 40 nm.

4. An apparatus as recited in claim 2, wherein said wavelength band has a bandwidth in the range of approximately 40 nm to approximately 100 nm.

5. An apparatus as recited in claim 1, wherein the optical grating provides corrective dispersion over a wavelength band that is the mirror image of said residual dispersion over said wavelength band.

6. An apparatus as recited in claim 1, said corrective dispersion includes an offset.

7. An apparatus as recited in claim 1, wherein said grating is a negative offset dispersion grating.

8. An apparatus as recited in claim 1, wherein said grating is a chirped fiber Bragg grating (FBG).

9. An apparatus as recited in claim 1, wherein said optical signal is input to an optical circulator, is routed to said grating, traverses said grating, is reflected by said grating back to said circulator, and is routed by said circulator to said DC optical fiber.

10. An apparatus as recited in claim 1, wherein said DC optical fiber includes said dispersion grating.

11. An apparatus as recited in claim 1, wherein said grating is a positive offset dispersion grating.

12. An apparatus as recited in claim 1, further comprising a length of trim fiber.

13. An apparatus as recited in claim 1, wherein said optical signal is input to an optical circulator; is routed to said DC optical fiber and traverses said DC fiber a first; is incident in said grating and is reflected back across said grating back to said DC fiber; traverses said DC fiber a second time; and is routed by said circulator to an optical link.

14. An apparatus as recited in claim 1, wherein said optical grating is adjustable to compensate for residual dispersion of dispersion compensating optical fibers having differing κ-values.

15. An apparatus as recited in claim 1, wherein said optical grating has a dispersion characteristic that is tailored for the κ-value of said dispersion compensating optical fiber.

16. An optical link, comprising:
dispersion compensating apparatus, including:
a dispersion compensating optical fiber, which substantially compensates for the chromatic dispersion in an optical signal; and
an optical grating, which substantially compensates for residual dispersion in said optical signal.

17. An optical link as recited in claim 16, wherein said dispersion compensating fiber and said optical grating compensate for chromatic dispersion compensates for dispersion over an entire wavelength band.

18. An optical link as recited in claim 17, wherein said wavelength band has a bandwidth in the range of approximately 40 nm to approximately 100 nm.

19. An optical link as recited in claim 16, wherein the link has a length in the range of approximately 10 km to approximately 200 km.

20. An optical link as recited in claim 16, wherein the link has a length in the range of approximately 100 km to approximately 200 km.

21. An optical link as recited in claim 20, wherein no other dispersion compensator is needed over said length of said link.

22. An optical link as recited in claim 16, wherein the optical grating provides corrective dispersion of a wavelength band that is the mirror image of said residual dispersion over said wavelength band.

23. An optical link as recited in claim 16, wherein said grating is a negative offset dispersion grating.

24. An optical link as recited in claim 16, wherein said grating is a positive offset dispersion grating.

25. An optical link as recited in claim 16, wherein the dispersion compensating apparatus further includes a trim fiber.

26. A method of compensating for chromatic dispersion over a wavelength band, the method comprising:
providing a dispersion compensating optical fiber, which provides dispersion compensation over the band; and
providing an optical grating that substantially compensates for residual dispersion in an optical signal.

27. A method as recited in claim 26, further comprising compensating for dispersion over an entire wavelength band.

28. A method as recited in claim 27, wherein said wavelength band is in the range of approximately 40 nm to approximately 100 nm.

29. A method as recited in claim 26, further comprising, providing corrective dispersion over a wavelength band that is the mirror image of said residual dispersion over said wavelength band.

30. A method as recited in claim 26, wherein said grating is adjustable to compensate for residual dispersion of dispersion compensating optical fibers having differing κ-values.

31. A method as recited in claim 26, wherein said grating has a dispersion characteristic that is tailored for the κ-value of said dispersion compensating optical fiber.
